(19) United States
(12) Patent Application Publication
(10) Pub. No.: US 2006/0134357 A1
(43) Pub. Date: Jun. 22, 2006

(54) Polymer blends for medical balloons

(75) Inventors: Raymond Godaire, Auburn, MA (US); Susheel Deshmukh, Santa Rosa, CA (US)

Correspondence Address: MEDTRONIC VASCULAR, INC.;IP LEGAL DEPARTMENT, 3576 UNOCAL PLACE, SANTA ROSA, CA, 95403, US

(73) Assignee: Medtronic Vascular, Inc., Santa Rosa, CA (US)

(21) Appl. No.: 11/015,595

(22) Filed: Dec. 16, 2004

(51) Int. Cl. B32B 27/32

(52) U.S. Cl. 428/35.2; 264/500

(57) ABSTRACT

A dilatation balloon is disclosed comprising about 65-95 wt % polyamide blended with a second polymer selected from the group consisting of a polyurethane, a rubber and an ionomer, wherein the balloon has hoop strength of about 20,000-40,000 p.s.i. Also disclosed, is a process for forming the dilatation balloon. The process includes contacting the polyamide polymer with a composition comprising a second polymer to form a polymer blend, extruding the polymer blend to form a polymer extrudate, and forming the balloon from the extrudate in a balloon forming machine.

### BACKGROUND OF THE INVENTION

1. Field of the Invention

The present invention relates to the field of balloon dilatation. Specifically, the present invention relates to balloons for dilatation applications and a process for manufacturing the balloons.

2. Related Art

Angioplasty balloons are currently produced by a combination of extrusion and stretch blow molding. The extrusion process is used to produce the balloon tubing, which essentially serves as a pre-form. This tubing is subsequently transferred to a stretch blow-molding machine capable of axially elongating the extruded tubing. U.S. Pat. No. 6,328,710 B1 to Wang et al., discloses such a process, in which a tubing pre-form is extruded and blown to form a balloon. U.S. Pat. No. 6,210,364 B1; U.S. Pat. No. 6,283,939 B1 and U.S. Pat. No. 5,500,180, all to Anderson et al., disclose a process of blow-molding a balloon, in which a polymeric extrudate can be stretched in both radial and axial directions.

The materials used in balloons for dilatation are primarily thermoplastics and thermoplastic elastomers such as polyesters and their block co-polymers, polyamides and their block co-polymers and polyurethane block co-polymers. U.S. Pat. No. 5,290,306 to Trotta et al., discloses balloons made from polyesterether and polyetheresteramide copolymers. U.S. Pat. No. 6,171,278 to Wang et al., discloses balloons made from polyether-polyamide copolymers. U.S. Pat. No. 6,210,364 B1; U.S. Pat. No. 6,283,939 B1 and U.S. Pat. No. 5,500,180, all to Anderson et al., disclose balloons made from block copolymers.

The unique conditions under which balloon dilatation is performed requires extremely thin-walled, high-strength balloons that are flexible and trackable enough to be maneuvered through tiny vessels. Balloons made from high strength polymers, while exhibiting high burst strengths, exhibit less flexibility and trackability than desired. The addition of plasticizer to the materials increases the softness and flexibility of the balloon. However, the use of plasticizer can limit the balloons applicability as a bio-compatible material. Balloons that exhibit high burst strengths that can be used in stent delivery, but also exhibit high flexibility and trackability are desired. New balloon materials are therefore needed to tailor the properties of the balloon and produce high-strength and highly flexible balloons for medical applications.

### SUMMARY OF THE INVENTION

In one embodiment, the present invention relates to a dilatation balloon comprising about 65-95 wt % polyamide blended with a second polymer selected from the group consisting of a polyurethane, a rubber and an ionomer, wherein the balloon has hoop strength of about 20,000-40,000 p.s.i.

In another embodiment, the present invention relates to a process for forming a dilatation balloon. The process comprises contacting a polyamide with a composition comprising a second polymer to form a polymer blend, extruding the polymer blend to form a polymer blend extrudate, and forming the balloon from the extrudate in a balloon forming machine. The balloon comprises about 65-95 wt % polyamide, the second polymer is a polyurethane, a rubber or an ionomer, and the balloon has hoop strength of about 20,000-40,000 p.s.i.

In another embodiment, the present invention relates to a dilatation balloon comprising about 80-90% nylon 12 blended with a second polymer selected from the group consisting of semicrystalline EPDM and poly(ethylene-co-methacrylic acid) partially neutralized with a zinc salt, wherein the balloon has hoop strength of about 20,000-40,000 p.s.i.

### DETAILED DESCRIPTION OF THE INVENTION

It is desirable to improve the flexibility and trackability of dilatation balloons while limiting the use of plasticizers, which can migrate out of the balloon, and while maintaining a high degree of strength in the balloon. This would allow a surgeon to maneuver the balloon, and alternatively, a balloon and stent, through very small diameter vasculature that may have a large degree of blockage or plaque build-up, and provides the surgeon with maximum flexibility to inflate the balloon without bursting it. In order to improve the flexibility of standard balloons without the use of plasticizers, or alternatively, with the limited use of plasticizers, a softer and more flexible material is blended into the balloon base material.

In one embodiment, the present invention relates to a dilatation balloon comprising about 65-95 wt % polyamide blended with a second polymer selected from the group consisting of a polyurethane, a rubber and an ionomer, wherein the balloon has hoop strength of about 20,000-40,000 p.s.i.

Dilatation is used herein to refer to the expandability of the balloon. Balloons of the present invention are expandable about 2% to about 40% greater than the original balloon size. Preferably, the expandability of the balloon is in the range of about 5% to about 20%

Hoop strength is directly related to the maximum amount of pressure the balloon can withstand, for a given wall thickness, without failing or bursting. The balloons of the present invention have high hoop strengths. High hoop strength is used herein to refer to balloons that have hoop strengths greater than about 20,000 p.s.i. Balloons of the present invention preferably have hoop strengths of about 20,000 to about 50,000 p.s.i., alternatively, about 20,000-40,000 p.s.i.

Polyamides for use in the present invention include any polyamide that exhibits high hoop strength when formed into a dilatation balloon. Specific examples include, but are not limited to, nylon-type polyamides, such as, nylon-6, nylon-11, nylon-12, nylon-4/6, nylon-6/6 and nylon-6/10. A specific example includes, but is not limited to, AESNO® nylon-12, available from Atofina Chemicals, Inc. (Philadelphia, Pa.). Balloons of the present invention comprise about 65-95 wt % polyamide. The amount of polyamide used in any particular balloon depends on several factors, including, but not limited to, the type of second polymer that will be blended with the polyamide and the desired final properties of the balloon. The balloon should have the same hoop strength or better than the base polyamide alone, while having improved flexibility over the base polyamide alone. Preferably, balloons of the present invention comprise about 80-90 wt % polyamide. The molecular weight of the polyamide polymer used in the invention is in the range of about 5,000 to about 5,000,000 Dalton.

Second polymers for use in the present invention include any polymer that is compatible and can be blended with the polyamide. Such polymers include, for example, but are not limited to: polyalkanes, polyhaloalkanes, polyalkenes, polyethers, polyesters, polycarbonates, polyamides, polyurethanes, polysulfones, polyketones, polysaccharides, polyamines, polyimines, polyphosphates, polyphosphonates, polysulfonates, polysulfonamides, polyphosphazenes, polysiloxanes and copolymers thereof.

The term “compatible” is used herein to refer to the characteristics of the blend of the two polymers. The polymers in the blend are compatible when they form a chemically stable blend. The blends are chemically stable when substantially no phase separation of the polymers occurs on the bulk scale, under the conditions used during manufacturing, processing and deploying the dilatation balloons of the present invention. It is understood by one of skill in the relevant art that two polymers are more compatible when their corresponding chemical structures are more similar. Also, the polymers of the present invention can be made more compatible, and their corresponding blends made more chemically stable, by chemically bonding a portion of one polymer to a portion of the second polymer. For example, the polyamides can be covalently bonded to rubbers functionalized by maleic anhydride to form covalent chemical bonds between the two polymers and to increase their compatibility.

Preferred examples of the second polymer include, but are not limited to polyurethanes, rubbers and ionomers. Specific examples of polyurethanes for use in the present invention include, but are not limited to, polyurethane-polyether copolymers. One class of polyurethane-polyether copolymers for use in the present invention includes those produced by the reaction of a polyol, an aromatic diisocyanate, and a low molecular weight glycol used as a chain extender. Alternative, specific examples of polyurethane-polyether copolymers include, but are not limited to, SPANDEX® copolymer sold by DuPont Chemical, Inc. (Wilmington, Del.), ELASTHANE® copolymer sold by The Polymer Technology Group, Inc. (Berkeley, Calif.), ESTANE® copolymer, TECOFLEX® copolymer, and TECOTHANE® copolymer sold by Noveon, Inc. (Cleveland, OH); and polyether based polyurethane copolymers such as PELLETHANE® 2363-80AE copolymer sold by Dow Chemical Company (Midland, Mich.).

Preferred rubbers include functionalized rubbers that are compatible with polyamides. Specific examples include, but are not limited to copolymers, wherein a first component is polyisoprene, EPDM (ethylene-propylene diene monomer), polybutadiene, SEBS (styrene-ethylene/butylene-styrene) or EPR (ethylene-propylene rubber), and a second component that imparts functionality to the rubber. Examples of the second component include, but are not limited to maleic anhydride, ethylene acrylic acid and the like. Preferably, the copolymer is a graft-copolymer, wherein the second component is grafted onto the first component. The amount of the second component is between 0.001-10 wt %. The second component preferably comprises a reactive portion that forms a covalent bond with the polyamide to give greater stability to the blend. Specific preferred examples of functionalized rubbers for use include, but are not limited to, amorphous or semicrystalline EPDM polymers with grafted maleic anhydride (about 0.005-0.01 wt %), for example, Royaltuf™ 482, 485 or 498 rubbers available from Crompton Corporation (Taft, La.), and SEBS with grafted maleic anhydride (about 2 wt %), for example, product number 43,243-1 available from Aldrich Chemicals (Milwaukee, Wis.).

Preferred ionomers include ionomers that are compatible with polyamides. Specific examples include copolymers of ethylene and an acidic monomer. Acidic monomers for use in ionomers of the present invention include, but are not limited to acrylic acid, methacrylic acid, maleic acid and the like. The acidic monomer is partially neutralized with a metal salt. For example, the acidic monomer is about 10-80% neutralized, preferably about 30-70% neutralized. Any salt of sufficient basicity can be used to neutralize the acidic portion and form the ionomer. Preferably, a metal salt of sufficient basicity is used and results in a ionomer that is compatible with the polyamide. Examples of metal salts include, but are not limited to salts of lithium, sodium or zinc, for example, zinc acetate, or the like, is used. Specific examples of ionomers for use include, but are not limited to SURLYN® 9020 ionomer, available from DuPont Chemical, Inc. (Wilmington, Del.).

The molecular weight of the second polymer used in the invention is in the range of about 5,000 to about 5,000,000 Dalton. The amount of second polymer used in the formulation depends on, for example, the final properties desired and the compatibility of the second polymer and polyamide base polymer.

The balloon optionally further comprises a plasticizer. Plasticizer is used herein to mean any material that can decrease the flexural modulus of a polymer. The plasticizer may influence the morphology of the polymer and may affect the melting temperature and glass transition temperature. Examples of plasticizers include, but are not limited to: small organic and inorganic molecules, oligomers and small molecular weight polymers (those having molecular weight less than about 50,000), highly-branched polymers and dendrimers. Specific examples include: monomeric carbonamides and sulfonamides, phenolic compounds, cyclic ketones, mixtures of phenols and esters, sulfonated esters or amides, N-alkylolarylsulfonamides, selected aliphatic diols, phosphite esters of alcohols, phthalate esters such as diethyl phthalate, dihexyl phthalate, dioctyl phthalate, didecyl phthalate, di(2-ethylhexy) phthalate and diisononyl phthalate; alcohols such as glycerol, ethylene glycol, diethylene glycol, triethylene glycol, oligomers of ethylene glycol; 2-ethylhexanol, isononyl alcohol and isodecyl alcohol, sorbitol and mannitol; ethers such as oligomers of polyethylene glycol, including PEG-500, PEG 1000 and PEG-2000; and amines such as triethanol amine.

The balloon optionally further comprises an additive. Additive is used herein to refer to any material added to the polymer to affect the polymer's properties. Examples of additives for use in the invention include: fillers, antioxidants, colorants, crosslinking agents, impact strength modifiers, drugs and biologically active compounds and molecules.

In another embodiment, the present invention relates to a process for forming a dilatation balloon. The process comprises contacting a polyamide with a composition comprising a second polymer to form a polymer blend, extruding the polymer blend to form a polymer blend extrudate, and forming the balloon from the extrudate in a balloon forming machine. The balloon comprises about 65-95 wt % polyamide, the second polymer is a polyurethane, a rubber or an ionomer, and the balloon has hoop strength of about 20,000-40,000 p.s.i.

The polyamide and the composition comprising the second polymer can be contacted using any method known to one of skill in the relevant art to form the blend. The composition comprising the second polymer optionally further comprises a plasticizer or other optional additives. In one preferred example, the polyamide and the second polymer are batch-blended, and fed into a twin screw extruder where the polymers are blended, as a melt, in the extrusion process. The extrudate is a strand of blended polymers that is then pelletized. The pellets of blended polymer can then be used to produce the extrudate from which the balloon will be formed.

The extrudate is formed in a tubular shape using an extruder. Extruders for use in the present invention include any extruder capable of forming tubular-shaped articles. Examples of extruders include, but are not limited to, single screw and, or twin screw extruders. The pelletized, blended polymers are fed into the extruder and extruded through a die to form the tubular extrudate. The extrusion temperature depends on the actual polymer blend being extruded. In general, the extrusion is performed at a temperature sufficient to melt the blended polymers. For example, when extruding Nylon 12 blended with semicrystalline EPDM, the extruder may be heated such that the temperature of extrusion is about 210° C. to about 290° C., preferably about 210° C. to about 260° C. Tubular is used herein to mean a hollow, cylindrical-shaped article having an inner diameter, an inner circumference, an outer diameter and an outer circumference with a wall thickness between the outer and inner circumferences. The outer diameter for the tubular extrudate is about 0.0100 to about 0.0900 inches. The inner diameter for the tubular extrudate is about 0.0050 to about 0.0450 inches.

After forming the tubular extrudate, the extrudate is further processed in a balloon-forming step. The balloon-forming step is performed according to any one of the methods known to one of skill in the relevant art. For example, the stretching method of U.S. Pat. No. 5,948,345 to Patel et al. can be used. According to the method of Patel et al., a length of tubing comprising a biaxially orientable polymer or copolymer is first provided having first and second portions with corresponding first and second outer diameters. Also provided is a mold having a generally cylindrical shape. The mold comprises a first, second and third portion having a corresponding first, second and third mold diameter. The first outer diameter of the tubing is larger than the first mold diameter. The tubing is placed in the mold and heated above the glass transition temperature of the polymer. Pressure is applied to the tube and the tube is longitudinally stretched such that it expands radially during the stretching. The tube is stretched about 2.5 to about 7 times the length of the tube's original length. A pressure of about 300 to about 500 p.s.i. is applied. A second higher pressure, about 15% to about 40% higher than the first pressure, is then applied and the tube is finally cooled below the glass transition temperature of the polymer. One skilled in the relevant art appreciates that much of the stretching process can be performed by automated equipment in order to lower per unit costs. Upon completion of the stretching, the balloon is attached to the distal end of a catheter body to complete the production of the catheter balloon.

Another embodiment relates to a dilatation balloon comprising about 80-90% nylon 12, blended with a second polymer selected from the group consisting of semicrystalline EPDM and poly(ethylene-co-methacrylic acid) partially neutralized with a zinc salt, wherein the balloon has hoop strength of about 20,000-40,000 p.s.i.

The following examples are illustrative, but not limiting, of the method and compositions of the present invention. Other suitable modifications and adaptations of the variety of conditions and parameters which are relevant to those skilled in the relevant art are within the spirit and scope of the invention.

### EXAMPLES

In the following examples a series of second polymers were blended with AESNO® SA-01 grade nylon 12 and the physical and mechanical properties of the blends were tested. The amounts of the second polymer were varied. Control samples were also studied. The composition of one control sample was AESNO® SA-01 grade nylon 12 only. A second control sample was plasticized AESNO® SA-01 grade nylon 12. The polymer blend samples were blended in a twin screw extruder and the blends were injection molded into dog bone shaped articles for testing in accordance with ASTM standards, as is well known to one of skill in the relevant art.

Table 1 shows the results of the studies. The results include the tensile strength and flexural modulus retained. The tensile strength retained measures the tensile strength of the blended material and compares it to the sample made of only nylon 12. A retained tensile strength of greater than 100% results from a blended material having increased tensile strength over the material made of only nylon 12. An increase in the tensile strength of a given material, all other things being equal, is desirable because those materials can lead to balloons having increased hoop strengths compared to the balloon made only from nylon 12.

The flexural modulus retained measures the flexibility of the blended material and compares it to the sample made of only nylon 12. A flexural modulus of less than 100% results from a blended material having decreased flexural modulus compared to the material made of only nylon 12. A decrease in the flexural modulus of a given material, all other things being equal, is desirable because those materials can lead to balloons having increased flexibility compared to the balloon made only from nylon 12. Alternatively an increase in elongation at break is also desirable because those materials can also lead to balloons having increased flexibility and toughness.

In particular, the results show that by blending discrete amounts of a second polymer with the AESNO® SA-01 grade nylon 12, the tensile strengths of the blended material can be maintained or in some cases increased while, simultaneously, the flexural modulus can be decreased. These blended materials, therefore, have equal to or higher tensile strength with lower flexural modulus, which can lead to dilatation balloons having higher hoop strengths and greater flexibilities than balloons made from only nylon 12 alone.

TABLE 1
Mechanical and Physical Test Results on Polymer Blends

| Blend | | | | | |
|---|---|---|---|---|---|
| Compo- | | | | Tensile | Flexural |
| sition | Tensile | Elon- | Flexural | Strength | Modulus |
| (wt %) | Modulus | gation | Modulus | Retained | Retained |
| AESNO ® | 243,300 | 76% | 179,300 | n/a | n/a |
| nylon 12 | | | | | |
| Plasti- | 72,900 | 214% | 70,100 | 87% | 39% |
| cized | | | | | |
| AESNO ® | | | | | |
| 5% | 196,300 | 205% | 153,500 | 107% | 86% |
| amorphous | | | | | |
| EPDM | | | | | |
| 10% | 176,700 | 219% | 140,100 | 100% | 78% |
| amorphous | | | | | |
| EPDM | | | | | |
| 20% | 140,000 | 82% | 122,800 | 67% | 68% |
| amorphous | | | | | |
| EPDM | | | | | |
| 5% Semi- | 196,600 | 239% | 170,000 | 113% | 95% |
| crystal- | | | | | |
| line | | | | | |
| EPDM | | | | | |
| 10% Semi- | 170,200 | 223% | 146,900 | 101% | 82% |
| crystal- | | | | | |
| line | | | | | |
| EPDM | | | | | |
| 20% Semi- | 127,500 | 252% | 114,000 | 93% | 64% |
| crystal- | | | | | |
| line | | | | | |
| EPDM | | | | | |
| 30% Semi- | 56,059 | 213% | 174,901 | 65% | 98% |
| crystal- | | | | | |
| line | | | | | |
| EPDM | | | | | |
| 50% Semi- | 33,213 | 396% | 82,157 | 61% | 46% |
| crystal- | | | | | |
| line | | | | | |
| EPDM | | | | | |
| 70% Semi- | 12,492 | 460% | 12,232 | 37% | 7% |
| crystal- | | | | | |
| line | | | | | |
| EPDM | | | | | |
| 10% | 168,400 | 204% | 148,400 | 102% | 83% |
| SURLYN ® | | | | | |
| 9020 | | | | | |
| 20% | 146,600 | 13% | 113,700 | 75% | 63% |
| SURLYN ® | | | | | |
| 9020 | | | | | |
| 5% SEBS | 193,400 | 237% | 155,600 | 111% | 87% |
| 10% SEBS | 180,200 | 83% | 142,500 | 87% | 79% |
| 20% SEBS | 152,200 | 205% | 130,400 | 87% | 73% |

It will be understood by those skilled in the relevant art that various changes in form and details may be made therein without departing from the spirit and scope of the present invention as defined in the appended claims. Thus, the breadth and scope of the present invention should not be limited by any of the above-described exemplary embodiments, but should be defined only in accordance with the following claims and their equivalents.

What is claimed is:

1. A dilatation balloon comprising about 65-95 wt % polyamide blended with a second polymer selected from the group consisting of a polyurethane, a rubber and an ionomer, wherein said balloon has hoop strength of about 20,000-40,000 p.s.i.

2. The balloon of claim 1, wherein said polyamide is a nylon polymer.

3. The balloon of claim 2, wherein said nylon polymer is nylon-6, nylon-11, nylon-12, nylon-4/6, nylon-6/6 or nylon-6/10.

4. The balloon of claim 3, wherein said nylon polymer is nylon 12.

5. The balloon of claim 1, wherein said polyamide is present in about 80-90 wt %.

6. The balloon of claim 1, wherein said polyurethane is the reaction product of a polyol, an aromatic diisocyanate, and a low molecular weight glycol used as a chain extender.

7. The balloon of claim 6, wherein said polyurethane is ELASTHANE® copolymer.

8. The balloon of claim 1, wherein said polyurethane is a polyurethane-polyether or polyurethane-polyester copolymer.

9. The balloon of claim 8, wherein said polyurethane is ELASTHANE® copolymer, PELLETHANE® copolymer, ESTANE® copolymer, TECOFLEX® copolymer or TECOTHANE® copolymer.

10. The balloon of claim 1, wherein said rubber is a functionalized rubber.

11. The balloon of claim 7, wherein said functionalized rubber is a copolymer, wherein a first component is polyisoprene, EPDM (ethylene-propylene diene monomer), polybutadiene, SEBS (styrene-ethylene/butylene-styrene) or EPR (ethylene-propylene rubber), and a second component is maleic anhydride or ethylene acrylic acid.

12. The balloon of claim 11, wherein said second component is grafted onto said first component.

13. The balloon of claim 1, where said ionomer is a copolymer of ethylene and a second acidic monomer selected from the group consisting of acrylic acid, methacrylic acid and maleic acid;
wherein said second acidic monomer is partially neutralized with a metal salt.

14. The balloon of claim 13, wherein said second acidic monomer is about 30-70% neutralized.

15. The balloon of claim 14, wherein said metal salt is a lithium, sodium or zinc salt.

16. The balloon of claim 15, wherein said ionomer is SURLYN® 9020 ionomer.

17. The balloon of claim 1, further comprising a plasticizer.

18. The balloon of claim 1, further comprising at least one of a filler, antioxidant, colorant, crosslinking agent, impact strength modifier, drug or biologically active material.

19. A process for forming a dilatation balloon, comprising:
contacting a polyamide with a composition comprising a second polymer to form a polymer blend;
extruding said polymer blend to form a polymer blend extrudate; and
forming said balloon from said extrudate in a balloon forming machine,
wherein said balloon comprises about 65-95 wt % polyamide, said second polymer is a polyurethane, a rubber or an ionomer, and said balloon has hoop strength of about 20,000-40,000 p.s.i.

20. A dilatation balloon comprising about 80-90% nylon 12 blended with a second polymer selected from the group consisting of semicrystalline EPDM and poly(ethylene-co-methacrylic acid) partially neutralized with a zinc salt, wherein said balloon has hoop strength of about 20,000-40,000 p.s.i.
